(19) United States
(12) Patent Application Publication
(10) Pub. No.: US 2014/0019173 A1
(43) Pub. Date: Jan. 16, 2014

(54) ENTERTAINMENT ARRANGEMENT SYSTEM

(71) Applicant: FanFair Systems Inc., (US)

(72) Inventor: Sacha Henry Spindler, Vancouver (CA)

(21) Appl. No.: 13/794,524

(22) Filed: Mar. 11, 2013

Related U.S. Application Data
(60) Provisional application No. 61/671,595, filed on Jul. 13, 2012.

(51) Int. Cl. G06Q 10/02

(52) U.S. Cl. CPC G06Q 10/02
USPC 705/5

(57) ABSTRACT

Methods, systems, and apparatus, including computer programs and including a method for matching followers to a performance to be held at a venue by a vendor are provided. The method includes polling followers of a vendor to determine a number of followers interested in committing to attend a performance at a physical venue and receiving pledges from followers to attend the performance. The method further includes identifying matching venues for hosting/sourcing the performance including reviewing venue requirements associated with candidate venues and identifying matching venues based on venue requirements of a respective venue and, for example, a number of pledges received. The method further includes providing a notification of a match to an entity associated with a matching venue, receiving an indication from the entity that the vendor is interested in hosting/sourcing the performance, and providing a notification to the followers including providing a code for attending the performance.

### BACKGROUND

This specification relates to matching audiences and venues for performances.

A band or other performance entity may have performances at a variety of venues, both small and large. A large band, one that is financially successful may be able to directly negotiate with a venue to host such a performance. Small bands may have many followers, or fans, that are interested in seeing performances of a respective band. The bands may have a fan base, for example, that is local or regional. A small band may not be capable of direct negotiations, due to sophistication or other issues, nor is it always possible to plan a performance to meet the demands of their fans. Typically, a venue may have requirements to be met for performances, such as a minimum number of people who show up for a performance. Absent some proof of past success or other guarantees, booking of such venues becomes impractical if not impossible.

### SUMMARY

In general, one innovative aspect of the subject matter described in this specification can be implemented in methods that include a computer-implemented method for grouping followers of a vendor (e.g., a band) so as to achieve access to a venue. The method comprises polling followers of a vendor to determine a number of followers that would be interested in committing to attend a performance associated with the vendor at a physical venue. The method further comprises receiving pledges from followers based at least in part on the polling. The method further comprises identifying matching venues from a plurality of venues for hosting the performance including reviewing venue requirements associated with candidate venues and identifying one or more matching venues based at least in part on venue requirements of a respective venue and a number of pledges received. The method further comprises providing notification of a match to an entity associated with a matching venue. The method further comprises receiving an indication from the entity and responsive to the notification that the vendor is interested in hosting the performance. The method further comprises providing a notification to the followers that have provided pledges responsive to the polling including providing the followers a code for attending the performance.

These and other implementations can each optionally include one or more of the following features. The follower can be a fan. The vendor can be a musical act. The venue can be a club. The followers can follow the vendor on a social network. The followers can be fans of the vendor. The venue requirements can include a number of pledges required to be a candidate to host a performance at the venue. The notification can be a notification on a social web site associated with the vendor. The code can be a Quick Response (QR) code that serves as a ticket to attend the performance. The notification further can include a request to pay for the pledge prior to receiving the code. The method can further comprise providing a user interface associated with the vendor for receipt of pledges from followers. The method can further comprise providing other content about the vendor to users who view the user interface. The other content can be sponsored content.

Particular implementations may realize none, one or more of the following advantages:

For example, a networked computer system can construct and display a multi-purpose mobile handset, tablet application and web portal (WP) that is based, for example, on a Mobile Interactive Entertainment Generator Application (MIEGA). The MIEGA can produce a virtual environment and web portal that is multi-functional in that they function as, for instance, a commercial environment, a social networking environment, a media/entertainment/sports environment, with gaming environment attributes, thereby meeting a variety of needs of a variety of users all within a single mobile handset application and internet portal.

In another example, through the virtual environment, a vendor of the virtual environment (e.g., a band) navigates varying options that can provide the users (e.g., users that are associated with the vendor, such as through existing social media portals) whom have previously opted-in to receiving outreach from the vendor (such as with social media like Facebook, Twitter, MySpace, etc.) offers/opportunities to receive Entertainment Event and Product Offerings (EPO) from the vendor. A users response to the vendor offer/opportunities results in the users being placed into a form of Virtual Holding Room (VHR), which functions much the same as a “lineup” an individual would be part of waiting to get to the door of an event venue to purchase a ticket to an entertainment event along with other users who have similarly responded to the offerings from the vendor. The users in the VHR will be provided the option at a later date from the vendor to confirm their e-commerce transaction of the offering.

In another example, the virtual environment is a virtual environment which a registered business merchant (Merchant) that provides Venue Space (VS) for various functions has specified Sets of Criteria (SOC) within the virtual environment that must be met by a vendor such that the Merchant will receive from the virtual environment confirmation of the specified Merchant SOC being met by a Vendor resulting from the amount of users the vendor has compelled into the VHR.

In another example, the vendor can receive the offering from the Merchant through the virtual environment (MER-OFR) where the virtual environment will, as a result, enable the vendor to send a follow up offer to the users placed in the VHR, whereby the users can then elect to complete the e-commerce purchase transaction.

In another example, the user can input their payment method and payment information details into the virtual environment e-commerce functionality and when those payment method details are received and confirmed by the virtual environment and the e-commerce payment real world monies are received in an E-Commerce Holding Room (ECHR) of the virtual environment, the Merchant that provided the MER-OFR to the vendor will be notified by the virtual environment when the amount of user payment confirmations meet the Merchant SOC.

In another example, the virtual environment can provide the vendor and the Merchant the option to track the statistics of the above described e-commerce purchases several sets of information generator options available within the virtual environment.

In another example, the virtual environment can release to the confirmed user whose payment has been received by the virtual environment for the offering a QR Code (QRC) that can be authenticated and tracked by the virtual environment through, for example, internal and external methods, which can be scanned at the venue. In some implementations, scanning the QRC will upload additional details to the virtual environment, specifically concluding the virtual environment cycle for each such transaction.

In another example, the virtual environment can aggregate all real world monies received by the virtual environment in the ECHR from completed e-commerce transactions from users who have paid real world monies for their purchases (consummated transactions) and at some time subsequent (e.g., to the date the event was held or the ticket sold to the user), the monies held within the ECHR will concurrently be directed from the ECHR to the virtual environment, the Vendor and the Merchant according to the pre-arranged percentages of interest of those monetary proceeds.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for facilitating performances by a vendor and to be held at a venue.

FIG. 2 shows example flows of communications, revenues and goods and services within the system.

FIG. 3 is a flowchart of an example process for facilitating performances by a vendor and to be held at a venue.

Like reference numbers and designations in the various drawings indicate like elements.

### DETAILED DESCRIPTION

A system of integrated hardware and software components adapted as disclosed herein can match followers to a potential performance to be held at a venue by a vendor associated with the followers. In some implementations, the system comprises a core-computer that includes one or more CPUs, memory storage servers, graphics software, administrative software, and databases. Although the core computer is discussed in the singular, the term “system” includes whatever number of hardware and software components are required to obtain the objectives of the system and may include a plurality of computers functioning together to carry out the core functions of the system.

In some implementations, the system includes at least one mobile handset or tablet computer networked through a mobile application to at least one core computer. In some implementations, the system includes at least one user-computer networked with at least one core-computer. In some implementations, the system includes at least two user computers networked with at least one core computer and with each other. Networking can be accomplished through Internet connections and/or other networks.

Any personal computer device capable of being networked with a core-computer may be considered a user-computer, including by way of example, tablet computers, laptop computers, desktop computers, personal digital assistants (PDAs), and cell phones/mobile phones/mobile handsets. The user-computers may contain software elements of the system and/or they may be able to such run software elements that are not physically present in the user-computer but that reside at distant locations elsewhere within the system.

Participants can include humans that interact with the system. Participants can include different classes of participants. For example, a user can be a real-world person who is provided access to and/or is enrolled in the system generally in a consumer capacity. The user may be authorized by the system to purchase tickets, media content, and entertainment. A vendor can be a real-world person or entity that is enrolled in the system, generally in an offering capacity, for performances such as entertainment events, media/entertainment/sports events and content, etc., to users. A merchant can be a real-world person or entity that provides venue space and/or hosts media/entertainment/sports events and/or content for consumption by a user, including pre-recorded content, live productions, and artistic works. Depending on the nature of the rights sold, rights to access a given event at a venue may be delivered online or to a user's physical address. A producer can be a real-world person, professional or entity that provides services for hire of any nature whatsoever to users, vendors, merchants and the operator (e.g., operator of the system) in support of the activities undergoing in the virtual environment amongst those participants. The producer can also provide services and support to users accessing the virtual environment. An operator can be an aggregate of real-world people and entities that develop, maintain, and administer the system, including, without limitation, programmers, system analysts, directors, technicians. An operator can also serve other roles, such as a facilitator between vendors, merchants, users and the like. In some implementations, the operator can create event opportunities by recognizing a potential for a vendor to host an event and facilitating the event by coordinating among the vendor, the merchant and the users that follow a given vendor or other users that might be interested in a performance provided by the vendor.

The term simulated used herein refers to computer-simulation in a graphical format and is interchangeable with “virtual” and “digital” as those terms are employed in the art of computer graphics to distinguish computer-generated object-images from real, tangible real-world objects. “Simulated,” “virtual” and “digital” can refer to non-real objects and events that are constructed by a computer and displayed on a user-computer.

The term virtual environment can refer broadly to the simulated environment with which the operator, vendors, merchants, producers and users interact within the system disclosed herein.

The term Web Portal (WP) can refer to a web-based user interface, including software running under the operator's control or direction by which the operator, user, vendor, merchant and/or producer gains access to the virtual environment.

The term media content can be used broadly to refer to performances, events, news content, sports content, broadcasts, movies, shows, educational events, works of art, and other creative content whether provided to a user in a live venue environment or in some pre-recorded format, and whether provided in the real-world or through the virtual environment.

The term “Goods and services” (“G/S”) is applied herein according to its commonly accepted use to refer generally to objects of commercial intercourse. G/S may be real-world objects or simulated objects, as disclosed in detail below.

Objectives of the system described herein can be achieved by a computer system that constructs and displays an interactive computer-simulated environment to a vendor, merchant, producer and/or user in a manner that provides for one or more of the following functions to be performed:

Functions performed by the operator can include the following: providing and maintaining the system, controlling the virtual environment, maintaining the virtual environment, registration and administration of users, registration and administration of vendors, producers and merchants, maintaining a payment system, administering and over-seeing commercial transactions between vendors, producers, merchants and users, providing services to users, and providing services to vendors, producers and merchants including facilitating or hosting events as described in further detail below.

Controlling the virtual environment can include management of passwords or other means of verification, and enforcement of terms and conditions of use.

Maintaining the virtual environment can include providing and administrating a system of look-up directories or other search capabilities, providing amenities within the virtual environment, providing virtual environment venues for real-world and/or online events, and providing access to media content for legal downloading.

Registration and administration of users can include maintaining at least one user account, maintaining at least one user database, administering payments made by users to the operator, the vendors and merchants, administering payments made to the operator by producers, and administering payments made by vendors, merchants and users to producers.

Registration and administration of vendors, producers and merchants can include maintaining at least one vendor, one producer and one merchant account, maintaining at least one vendor, one producer and one merchant database, and administering payments made by vendors, producers and merchants to the operator. Maintaining a payment system can include establishing the ECHR within the virtual environment that holds real-world money from payments received by the virtual environment for financial transactions within the virtual environment. Providing services to users can include notification of tentative events, notification of events, providing live streaming of real world media content through the virtual environment, providing outlets for users to legally acquire media content, providing and maintaining incentive systems. Incentives to users may include real-world incentives such as G/S, media content, tickets to real world performances, etc. Incentives may also include simulated incentives like simulated currency, simulated G/S, access to events taking place within the virtual environment, etc., distributing G/S and media content directly to users, providing a business network, providing review and dissemination platforms, and providing simulated auctions within the virtual environment for bidding-sales of real-world G/S or simulated G/S.

Providing services to vendors, producers and merchants can include access to new users, and redeeming currency (e.g., to collect revenues from users and distribute to vendors, producers and merchants). Other services can include identifying opportunities for events, contacting vendors to create events, locating users that might be interested in events beyond those that follow a specific vendor and other facilitating services to create, organize, support, host and/or produce an event.

Functions performed by vendors, producers and merchants can include registering and contracting with the operator for services provided by the operator, designing advertising and buying advertising opportunities from the operator, and providing the operator with G/S to be distributed to users and/or to one another.

Functions performed by users can include registering with the operator for access to the virtual environment, purchasing G/S from vendors and/or producers in the virtual environment, purchasing access to entertainment/media events in the virtual environment and the real-world, attending entertainment/media events in the virtual environment, including pre-recorded content and live events, purchasing and downloading entertainment/media content from vendors or directly from producers and/or merchants, and generally interacting with the virtual environment.

Registering with the operator for access to the virtual environment can include providing personal and contact information, designating what personal information is to be available to other users, vendors, producers and merchants, and providing payment information.

Generally interacting with the virtual environment can include navigating from place to place, attending entertainment/media events, interacting socially with other users, transacting business as between vendors, producers and/or merchants and users, responding to virtual environment advertising, and carrying out real-world business, including making and maintaining business contacts, seeking real world employees, and seeking real world employment, gigs, etc.

Functions performed by producers can include providing entertainment/media content to vendors, merchants and the operator for distribution to vendors, merchants and users, providing live entertainment/media content directly to users through live streaming and real-world events, providing license agreements to the operator for legal distribution by operator of proprietary works, operating galleries and studios for direct distribution of media content and G/S to users, vendors and/or merchants, and providing forums and educational events.

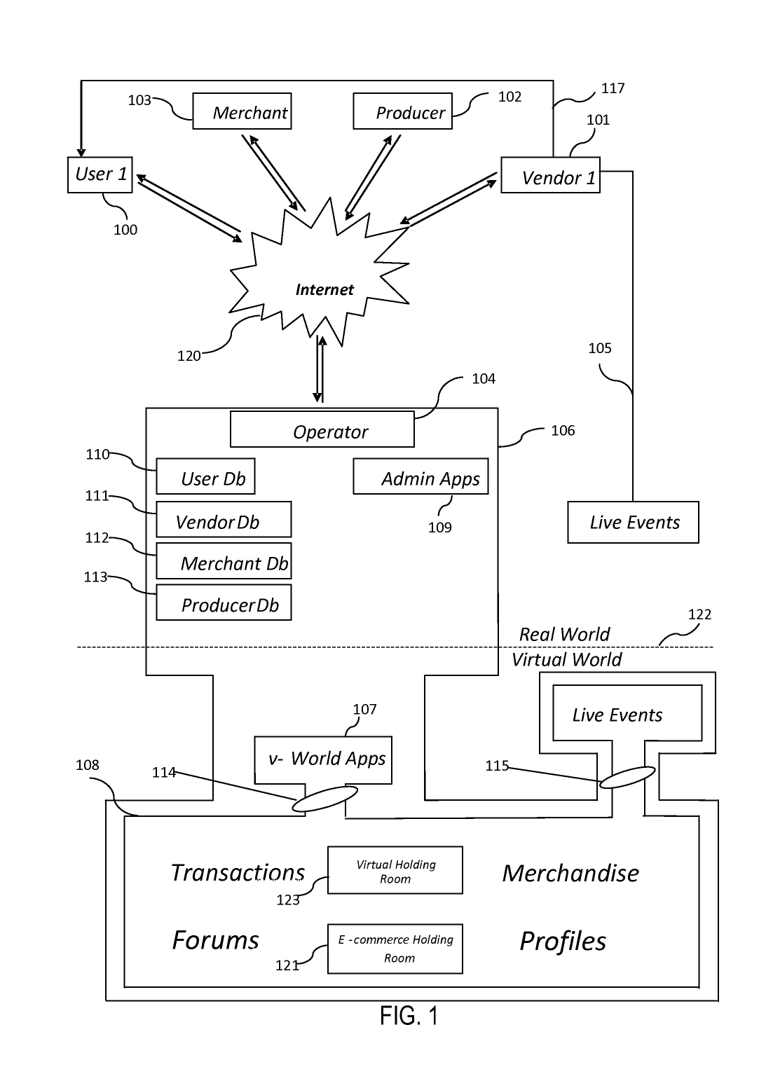

FIG. 1 is a block diagram of an example system for matching followers to a performance to be held at a venue by a vendor associated with the followers. To distinguish between people, objects and events in the real world from people, objects, and events in the virtual environment, horizontal line 122 represents an imaginary demarcation between the real world and virtual world. This demarcation is only for purposes of illustration. Everything below the line 122 exists within the system hardware and software in the real world. It is noted that the networking system, the Internet 120, is considered as a component of the real world even though it is largely an abstraction.

The participants described above are shown in FIG. 1 as User 100, Vendor 101, Producer 102, Merchant 103 and Operator 104. Although the singular may be used to describe these participants, it is understood that each category represents a plurality of individuals and, in many cases, companies, corporations, or other associations of individuals. Although not shown in the figure, each of the participants has (or access to) a mobile handset telephone and/or tablet computer and/or local computer for accessing the Internet 120. In some implementations, such mobile handset telephones and/or tablet computers and/or local computers may be considered as components of the overall system.

The participants may interact with each other in a number of ways, as summarized here. For example, Operator 104 provides access to virtual environment 108 to User 100, Vendor 101, Producer 102 and Merchant 103 through the Internet 120. User and Producer 102 make payments to Operator 104, such as in real-world currency, for the various services Operator 104 supplies. The payments can be held by Operator 104 in the 121 E-Commerce Holding Room. Vendor 101, Merchant 103 and Producer 102 receive payments from Operator 104. Upon purchase of G/S in the virtual environment by User 100, Vendor 101 may deliver the G/S to User 100 through the virtual environment. Vendor 101 may provide 105 entertainment and/or media content in the real world that is accessed by User 100 through the virtual environment, for instance by downloading of entertainment/media content and/or live streaming of an online production. Vendor 101 may also provide entertainment/media content for distribution to User 100 at 115 through the virtual environment. The flow of G/S and revenues is described in more detail below.

A core-computer 106 is shown in FIG. 1. Operator 104 is indicated as being associated with the core computer 106. This is, of course, a functional association as the various persons and components that comprise the Operator 104 may be geographically remote from the core computer.

Certain of the software components of the core computer 106 are illustrated. They include a database 110 of User information, a database 111 of Vendor information, a database 112 of Merchant information and a database 113 of Producer information. The data held in these databases include, by way of example, personal/identification information, account information, and security information such as passwords. The databases may also hold archived data, financial information, metrics associated with activities through use of the virtual environment, communications between participants, the virtual environment, the Operator 104, etc.

Core computer 106 can also include or have access to application files. Two types of such applications are indicated. First, there are administrative applications 109 used to access the databases and administer the system. Second, there are virtual environment applications 107, including graphics software, by which the virtual environment 108 can be constructed, maintained, and presented to the participants. Included in this category is software that constructs and maintains portal 114 by which participants gain access to the virtual environment. There may be a single general portal that handles all traffic into the virtual environment, or there may be individual portlets for individual subsets of the participants. In other words, the portal function represented by 114 can be customized so that it serves the different needs of the different participants.

Virtual environment applications 107 construct the virtual environment 108, which can be summarized as a graphical environment that participants interact with or within.

Vendor 101 may use the virtual environment to sell G/S of a type that may be delivered to User 100 through portal 114. The use of the Internet for online social networking paradigms is well known, including successful examples such as Facebook, Twitter and MySpace. The system can include a direct link by Vendor 101 through the virtual environment 108 to User 100 and Merchant 103 as a result of Vendor 101 having access to User 100 that have opted into Vendor 101 created profiles within social networking paradigms in varying geographical locations across the real or a virtual world, that provide Merchant 103 access to Vendor 101 and User 100, and provide User 100 and Vendor 101 access to Merchant 103. Vendor 101 may also use the virtual environment 108 to communicate with User 100 and Merchant 103 and Merchant 103 may use the virtual environment 108 to communicate with Vendor 101 and to User 100 through Vendor 101.

Also shown in FIG. 1 is what may be denoted a “temporary exit portal” 115. This is a component of the virtual environment application that allows a User 100 who is “in” the virtual environment 108 to experience real-world events broadcast in and/or through the virtual environment 108. The User 100 remains logged into the system and thus is active in the virtual environment, but participates in events in the real world occurring in real time. This feature can be implemented by a variety of means. For instance, live video from an event can be streamed to the core-computer 106 and that live video is then distributed by the Operator 104 to User 100 who have, for example, paid a fee to view the event. Alternatively, video of the event may be streamed directly to the user's mobile handset and/or tablet computer and/or computer through the Internet 120 after the user has been granted access by the operator, for instance, after receiving a fee from the user.

The administrative applications 109 and the virtual environment applications 107 interact to provide the functionality of the system. For instance, User 100 can view products and make purchases in the virtual environment 108 making use of the graphics functionality of the virtual environment applications working in tandem with the administrative applications modifying the various databases to reflect payments made to, held within and distributed from the E-Commerce Holding Room 121. In some implementations, all of these functions operate in real time in order to provide the User 100 a simulated experience that may produce real-world effects, such as the delivery of G/S to the User 100.

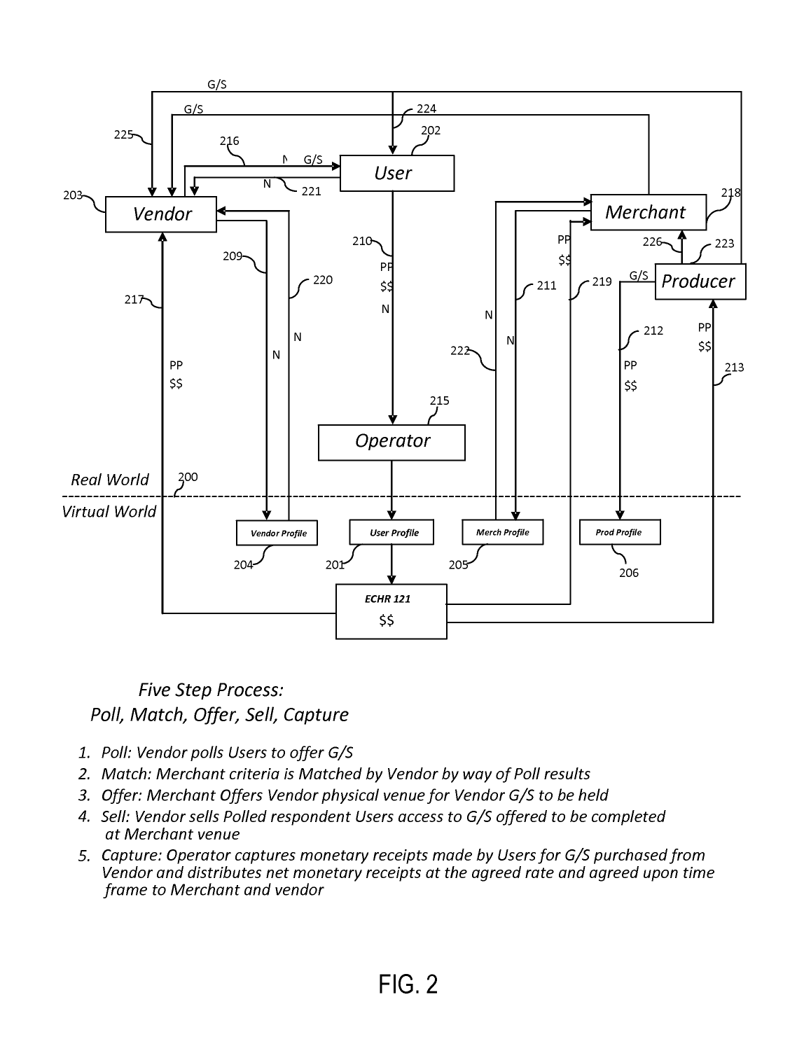

FIG. 2 shows example flows of communications, revenues and goods and services within the system. In the figure and in the following description, real-world money is symbolized as “$$”; “G/S” symbolizes both goods/services and media content; “N” symbolizes notifications from one and/or many participant(s) to another and/or others; and, “PP” symbolizes payment points. The line 200 represents a fictional boundary between the real-world transactions above the line, and transactions occurring at least in part in the virtual environment below the line.

At 209, the operator sets up a record for the vendor in Vendor database 111 and provides the vendor with access to the portal 114 and provides the vendor presence in the virtual environment 108 by means of a profile (e.g., vendor profile 204). Thereafter, the operator can assist in the deployment of Vendor 203 G/S (e.g., offers) to Users 100.

At 210, the operator sets up a record for user in User database 110 and provides the user with access to the portal 114 and provides user presence in the virtual environment 108 with reference to a user profile 201. The user accesses the virtual environment 108 through Internet 120. The operator also sets up an account for the user and can provide user software that the user downloads and retains in a user device (e.g., a computer and/or on a user's mobile device) in order to acquire G/S from Vendor 203, Merchant 218 and/or Producer 223 through the virtual environment 108. In some implementations, user accesses the virtual environment using a thin client providing requests to a server that executes the methods described herein. In some implementations, transactions are referred to as “Payment Points (PP).” By means of these annotations to the user's record in the user database 110, the user now has access to purchase G/S through the virtual environment 108.

At 211, the operator sets up a record for merchant in the merchant database 112 and provides merchant with access to the portal 114 and provides merchant presence in the virtual environment 108 a merchant profile 205. The operator can also set up an account for the merchant and establishes the merchant with access to G/S provided by the operator to assist deployment of merchant G/S.

At 212, the operator sets up a record for a producer in the Producer database 113 and provides the producer with access to the portal 114 and provides producer presence in the virtual environment 108 using a producer profile 206. The operator can also set up an account for the producer and establishes producer access to distribute G/S by the operator to user, vendor and merchant through the virtual environment 108. By means of these annotations to the producers record in the producer database 113, the user, vendor and merchant now have access to purchase and/or receive G/S through the virtual environment 108, the real world currency payments to 223 the producer of which are transferred by the virtual environment 108 at 213 to producer 223 from E-Commerce Holding Room 121.

A summary follows of an example configuration of transaction elements of the participants. At 216, Vendor 203 through the Internet 120 polls User 202 of a conditional G/S offer from Vendor 203 to User 202 of a future G/S, whereby User 202 can choose to accept conditional the G/S offer from Vendor 203. While reference is made of polling by Vendor 203, the operator may initiate polling to create and/or facilitate an event. At 221, User 202 notifies Vendor 203 (or the operator) of User's acceptance of the conditional G/S by means of 204 Vendor and by doing so, at 210 User 202 is placed into Virtual Holding Room 123 through access of the virtual environment 108. This may be for a future one-time purchase of G/S from Vendor 203 and/or for continuing purchases of G/S from Vendor 203 and/or other Vendors in the virtual environment 108.

When Users 202 increase in number to an amount that equals or surpasses the predetermined required amount established by Merchant 218 the merchant receives automatic notification from the virtual environment 108 of that criteria being matched as a result of User 202 acceptances of poll from Vendor 203. At 222 the virtual environment 108 automatically notifies Merchant 218 using the profile that the Vendor 203 has met Merchant 218 criteria established for the merchant. The virtual environment 108 requests Merchant 218 to confirm acceptance of Vendor 203 notification sent to Merchant 218 by the virtual environment 108, and at 211 Merchant 218 sends confirmation notification through the virtual environment 108 to 204 Vendor advising Vendor 203 of Merchant 218 acceptance of notification that Vendor 203 has met Merchant 218 criteria.

At 220, Vendor 203 receives the Merchant conditionally accepting notification, wherein the virtual environment 108 then enables Vendor 203 at 216 to notify User 202 within Virtual Holding Room 121. In some implementations where the operator and not the vendor has initiated the polling, the vendor can be brought into the process either before or just after confirmation from the merchant. The User 202 now has the option to complete the purchase from Vendor 203 of the G/S conditionally offered by Vendor 203 to User 202 prior thereto.

At 210, the virtual environment 108 receives, for example, real world currency from User 202 in exchange for purchasing G/S from Vendor 203 and/or Producer 223, where currency from User 202 is held in E-Commerce Holding Room 121. At 220, the virtual environment 108 sends to Vendor 203 QR Codes for each User 202 G/S purchase from Vendor 203 that Vendor 203 can distribute to User 202 that can be scanned by a commonly utilized digital scanning device at Merchant 218 when User 202 redeems the G/S purchased from Vendor 203.

In some implementations, twenty four hours subsequent to when G/S are rendered/delivered by Vendor 203 on behalf of User 202 at Merchant 218, agreed upon amounts of real world currency accrued in E-Commerce Holding Room 121 for said G/S transaction are released to Vendor 203 and to Merchant 218. In some implementations, the virtual environment 108 provides distribution of real world currency to 204 Vendor and 205 Merchant through real world currency transmission and distribution services established and provided by Operator to Vendor 203 and Merchant 218.

At 212, Producer 223 is able to gain producer access to the virtual environment 108 by paying, for example, money ($$) to the operator. Producer 223 can then offer G/S to User 202 at 224; to Vendor 203 at 225; and to Merchant 218 at 226. The virtual environment 108 accrues real world currency received on behalf of 206 Producer in E-Commerce Holding Room 123 from G/S purchases made by User 202, Vendor 203 and Merchant 218 from Producer 223. The virtual environment 108 thereafter distributes real world currency receipts held in E-Commerce Holding Room 123 at the agreed upon rate to 206 Producer for receipt by Producer 223.

In some implementations, a User 202 gains priority access to Virtual Holding Room 121 by being invited by Vendor 203 (or the operator) in advance of the G/S offered by Vendor 203 being redeemed by User 202 at Merchant 218 and that in doing so, User 202 is on a virtual basis “waiting in line” in Virtual Holding Room 123, and as a result Merchant 218 is able to establish that Vendor 203 possesses the ability to meet the criteria established by Merchant 218 for hosting the performance.

In some implementations, when merchant criteria are met by Vendor 203, the Vendor 203 can notify User 202 that User 202 has the option to use its priority access inside of Virtual Holding Room 121 to complete its purchase of G/S from Vendor 203 because Vendor 203 has met the criteria established by Merchant 218, thus establishing the means by which User 202 is able to create the opportunity for the G/S to become a real world entertainment/media event.

In some implementations, User 202 real world currency received by the virtual environment 108 from purchases of G/S by User 202 from Vendor 203 are held in E-Commerce Holding Room 121 on behalf of the Parties, whereby Vendor 203 and Merchant 218 are able to access by way of Operator 104 statistical data sets through administrative applications 107 and 109 in order to assess the ongoing accruals of real world currency payable to them at a time (e.g., 24 hours subsequent to the Vendor 202 G/S entertainment/media event having been completed), historical statistical data's, etc.

In some implementations, some or all of the foregoing transactions take place in the real-world that is above line 200. Below line 200 (that which is within the virtual environment), vendor, user, merchant and producer notifications to and from one and the other, activities, transactions, etc. are managed by the virtual environment 108 and by the operator.

In some implementations, the system can include or produce an interactive computer simulated environment in which events take place in real time and have real-world consequences. In some implementations, real-time based applications can interface with real-time, real-world applications such as Facebook, Twitter, and MySpace. For instance, a user may “move” from real-time interactions in Facebook into the real-time simulated environment of the system, and vice versa. Similarly, a user existing in the virtual environment may send notifications, Emails and/or text messages to real-world individuals using applications with which the system is interfaced.

In some implementations, users can access various administrative and virtual environment applications with virtual environment-dependent applications running on mobile devices that function as a remote application of and to the virtual environment 108; and, of independent applications running on mobile devices. Thus, the system can provide for unique digital identifiers for each user to use as a digitally scanable certificate as proof of purchase of vendor goods and services through the virtual environment that can be redeemed by user at the merchant point of redemption from a user mobile device. In some implementations, the unique identifier remains with the user and can be used again and again for ongoing redemption of vendor purchases from various vendors from time to time. The system can provide for the user unique identifier to function on the user's mobile device, as well as to receive notifications on the user's mobile device of deadlines, appointments, and other events occurring as a result of the virtual environment. For instance, the user who is scheduled to attend a concert or sports event purchased from a vendor in the virtual environment can first receive confirmation from the virtual environment that the user unique identifier is activated for a specific good and services purchase, and thereafter receive notifications on his/her mobile device about the goods and services purchased including time sensitive reminders, etc.

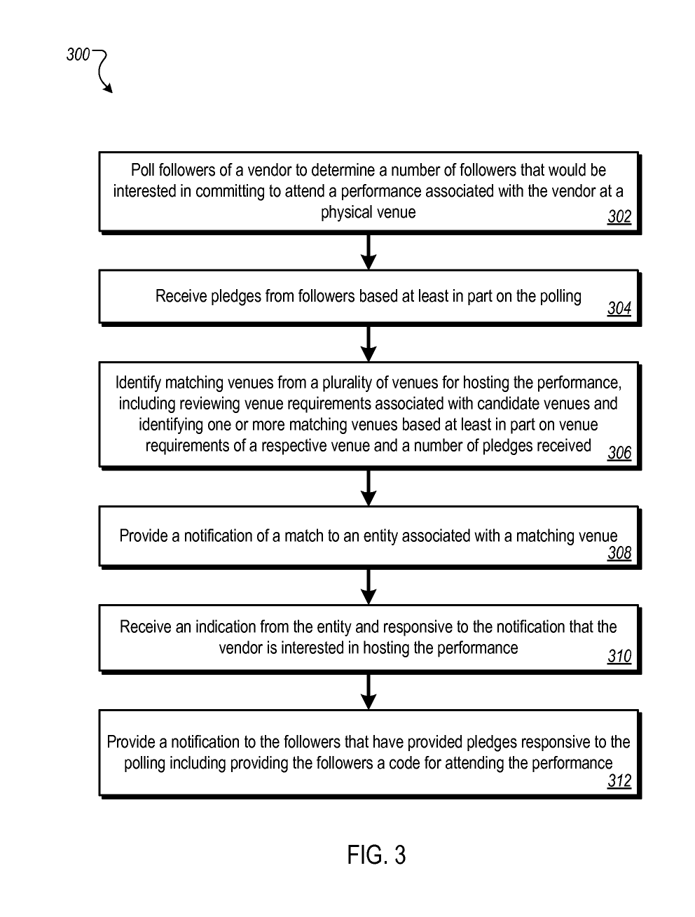

FIG. 3 is a flowchart of an example process 300 for matching followers to a performance to be held at a venue by a vendor associated with the followers. The process 300 can be performed by the core-computer 106 in association with interactions in the virtual environment 108. FIGS. 1 and 2 are used to provide example structures/interfaces associated with the steps of the process 300.

Followers of a vendor are polled to determine a number of followers that would be interested in committing to attend a performance associated with the vendor at a physical venue (302). For example, the vendor can be a musical act, such as a band or other performing group that has a local, regional or more widespread following. Followers, for example, can include consumers or fans of the vendor, e.g., fans of the band or other performing group. Followers may follow the vendor, for example, on a social network, such as fans who associate with the band's social network site or page in some way, e.g., through posting, subscribing, sharing, re-publishing, liking or some other positive affirmation. In some implementations, the followers can also be identified in ways outside of social networks, such as by email lists, online registrations, etc.

In some implementations, polling can be provided by the operator 104, e.g., to users 100 using the Internet 120 or other network(s). The polling can use information, for example, from data bases 110 through 113 and other information. For example, users to be polled can be identified from the database 110 of user information. Vendor information, e.g., identifying specific bands, can be obtained from the database 111 of vendor information. Venue information, e.g., identifying a specific place to hold a performance, can be obtained from the database 112 of merchant information.

Committing to attend a performance associated with the vendor at a physical venue is just one example of a commitment that can be made by a follower and for which polling can occur. Other commitments can include, for example, buying a product (e.g., a collection of songs, a movie, or other media), buying a service (e.g., restaurant meals, transportation arrangements, lodging, housecleaning, etc.), or arranging an event (e.g., a 5K race sponsored by the vendor).

Pledges are received from followers based at least in part on the polling (304). For example, users 100 can respond to the polling by committing to attend a performance of a particular vendor 101 (e.g., a specific local band) at a venue associated with a particular merchant 103. In some implementations, when a follower makes a pledge, information associated with the pledge can be generated and associated with the follower. For example, an entry can be automatically posted to the follower's news feed in a social network, e.g., “I just pledged to attend an upcoming performance of Example Band in my area.” In some implementations, pledges can be presented or used in ways other than those associated with social networks, such as by email, by telephone, be messaging (e.g., texting, SMS etc.), or by user entry on a web page. In some implementations, pledges that are received can include conditions selected by the user, such as cost ranges (e.g., including a maximum price) or geographic conditions (e.g., will only attend a concert within a 25-mile radius). Pledges can also include the number of people in the follower's party, such as if the follower plans to attend the performance with (and buy tickets for) friends or family.

In some implementations, a user interface associated with the vendor can be provided for the receipt of pledges from followers. For example, the user interface can provide sponsored content about the vendor (e.g., an advertisement associated with the band) to users (e.g., followers of a band). The sponsored content can include, for example, images, audio and/or video bites of the vendor, e.g., the band for which pledges are being received.

The preceding steps can occur repeatedly over time for several followers of one or more different vendors. For example hundreds or thousands or more fans of various bands can each make pledges to attend performances of one or more bands, or make pledges to consume products or services or attend events of other kinds.

Matching venues are identified from a plurality of venues for hosting/serving the performance including reviewing venue requirements associated with candidate venues and identifying one or more matching venues based at least in part on venue requirements of a respective venue and a number of pledges received (306). For example, matching merchants 103 (e.g., venues that include clubs, stages or theaters) can include identifying venues that may be capable of holding performances of the band or other performing group. In some implementations, the matching venues that are identified can be venues that can provide or sponsor the product, service or event for which the users have committed to buy tickets for, or attend the event. In some implementations, the venue requirements that are reviewed to match venues can include a number of pledges required by the venue before being a candidate to host a performance at the venue. For example, some venues may set minimum audience sizes for prospective performances based on revenue projections or other factors. In some implementations, the number of pledges required by the venue to be a candidate to host a performance can depend on the day of the week, the season, the type of performance, or other factors. In some implementations, matching venues can be identified, at least in part, in other ways, such as based on the size of the venue, the popularity of the venue with the public, and the vendors or venue's track record in attracting fans (e.g., in addition to pledged followers).

The matching can occur on an ongoing or scheduled basis to analyze existing pledges from users and determine whether an event can be proposed. For example, if fifty users, all followers of a particular band, have pledged to see a performance of the band at a particular venue on a specific date, and the merchant 103 associated with the venue has specified that a minimum audience of fifty is acceptable, then a match can occur. In some implementations, stale pledges can be periodically reaffirmed or pruned from an ongoing evaluation (i.e., pledges older than 6 months).

A notification of a match to an entity associated with a matching venue can be provided (308). For example, a merchant 103 (e.g., a proprietor in charge of the venue, such as a small downtown bar) can receive a notification (e.g., in a social network, by email, on a web site, in an application, or other ways) that the venue has been selected to host a performance (e.g., of Example Band on July 21^{st}).

An indication is received from the entity and responsive to the notification that the vendor is interested in hosting/serving the performance (310). For example, the merchant 103 (e.g., the proprietor in charge of the venue) can reply to the notification in an affirmative way to accept the invitation to host the band's performance.

A notification is provided to the followers that have provided pledges responsive to the polling including providing the followers a code for attending the performance (312). For example, users 100 who have pledged to attend the performance, can each receive a notification, e.g., that is sent by the operator 104.

In some implementations, a notification can occur on a social web site associated with the vendor. For example, the vendor social network home page can display an announcement of the upcoming event, including, for example, the date and time, the vendor (e.g., which band is playing), the number of fans who have already committed to attend the performance, and information for other potential audience members (e.g., controls by which additional fans can commit to the performance or buy tickets).

In some implementations, the code for attending the performance can be a Quick Response (QR) code or other scannable image that serves as a ticket to attend the performance. For example, all of followers (e.g., fans) who have committed to attend the performance of the band can receive QR codes on their cell phones, tablets, or other computing devices. Codes for attending the performance can occur in other formats, such as numeric codes, text codes, physical tickets, etc.

In some implementations, the notification provided to the followers can further include a request to pay for the pledge prior to receiving the code. For example, when the follower receives the notification identifying the upcoming concert, the notification can include a control or link that the user can select to display or navigate to a screen for paying for the ticket electronically.

In some implementations, steps of the example process 300 can be performed in other feasible orders that create the same or similar results. Moreover, other steps can be added.

While this specification contains many specific implementation details, these should not be construed as limitations on the scope of the system or of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
polling followers of a vendor to determine a number of followers that would be interested in committing to attend a performance associated with the vendor at a physical venue;
receiving pledges from followers based at least in part on the polling;
identifying matching venues from a plurality of venues for hosting the performance including reviewing venue requirements associated with candidate venues and identifying one or more matching venues based at least in part on venue requirements of a respective venue and a number of pledges received;
providing notification of a match to an entity associated with a matching venue;
receiving an indication from the entity and responsive to the notification that the vendor is interested in hosting the performance; and
providing a notification to the followers that have provided pledges responsive to the polling including providing the followers a code for attending the performance.

2. The method of claim 1 wherein the follower is a fan.

3. The method of claim 1 wherein the vendor is a musical act.

4. The method of claim 1 wherein the venue is a club.

5. The method of claim 1 wherein the followers follow the vendor on a social network.

6. The method of claim 1 wherein the followers are fans of the vendor.

7. The method of claim 1 wherein the venue requirements include a number of pledges required to be a candidate to host a performance at the venue.

8. The method of claim 1 wherein the notification is a notification on a social web site associated with the vendor.

9. The method of claim 1 wherein the code is a Quick Response (QR) code that serves as a ticket to attend the performance.

10. The method of claim 1 wherein the notification further includes a request to pay for the pledge prior to receiving the code.

11. The method of claim 1 further comprising:
providing a user interface associated with the vendor for receipt of pledges from followers.

12. The method of claim 11 further comprising:
providing other content about the vendor to users who view the user interface.

13. The method of claim 12 wherein the other content is sponsored content.
